(19) United States
(12) Patent Application Publication
(10) Pub. No.: US 2020/0162625 A1
(43) Pub. Date: May 21, 2020

(54) IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventors: Akihiro Mizutani, Mishima Shizuoka (JP); Hiroshi Watanabe, Yokohama Kanagawa (JP); Toshihiro Ida, Mishima Shizuoka (JP); Kazuhiro Ogura, Hiratsuka Kanagawa (JP); Takahiro Hagiwara, Chiba Chiba (JP); Kazuhiro Kamimura, Mishima Shizuoka (JP); Yusuke Hamada, Mishima Shizuoka (JP); Koji Endo, Susono Shizuoka (JP)

(21) Appl. No.: 16/750,036

(22) Filed: Jan. 23, 2020

Related U.S. Application Data
(63) Continuation of application No. 15/458,215, filed on Mar. 14, 2017.

(30) Foreign Application Priority Data
Jul. 11, 2016 (JP) 2016-136555

(51) Int. Cl. H04N 1/00; H04N 1/44

(52) U.S. Cl. CPC H04N 1/00339; H04N 1/4433; H04N 2201/0094; H04N 1/00076; H04N 1/00037; H04N 1/00917

(57) ABSTRACT

In accordance with an embodiment, the image forming apparatus comprises a display section, a connection section and a controller. The connection section connects with a device having a storage section. The controller detects connection and disconnection with the connection section and does not display a first screen displayed on the display section due to the connection with the device if the disconnection is detected.

### CROSS-REFERENCE TO RELATED APPLICATIONS

This application is a Continuation of application Ser. No. 15/458,215 filed on Mar. 14, 2017, the entire contents of which are incorporated herein by reference.

This application is based upon and claims the benefit of priority from Japanese Patent Application No. 2016-136555, filed Jul. 11, 2016, the entire contents of which are incorporated herein by reference.

### FIELD

Embodiments described herein relate generally to an operation at the time of attaching and detaching an external storage device to and from an image forming apparatus.

### BACKGROUND

There is known a technology for storing an image scanned by an image forming apparatus in an external storage device and printing, faxing or sending by an e-mail image data and document data stored in the external storage device by connecting the external storage device conforming a USB (Universal Serial Bus) standard to the image forming apparatus.

The following technology is disclosed.

### DESCRIPTION OF THE DRAWINGS

FIG. 1 is an external view illustrating an image forming apparatus according to an embodiment;

FIG. 2 is a pattern diagram exemplifying the internal constitution of the image forming apparatus according to the embodiment;

FIG. 3 is a block diagram exemplifying the constitution of the image forming apparatus according to the embodiment;

FIG. 4 is a diagram illustrating an example of a screen transition at the time a USB memory is connected to the image forming apparatus;

FIG. 5 is a diagram illustrating an example of a screen transition at the time the USB memory is removed from the image forming apparatus;

FIG. 6 is a view illustrating an example of returning to a screen before connection at the time of connecting and disconnecting the image forming apparatus with and from the USB memory;

FIG. 7 is a diagram exemplifying the operation at the time of connecting and disconnecting the image forming apparatus with and from the USB memory (first embodiment);

FIG. 8 is a diagram exemplifying the operation at the time of connecting and disconnecting the image forming apparatus with and from the USB memory (second embodiment);

FIG. 9 is a diagram exemplifying a screen display of a USB related software (third embodiment);

FIG. 10 is a diagram exemplifying the operation at the time of connecting and disconnecting the image forming apparatus with and from the USB memory (third embodiment);

FIG. 11 is a diagram exemplifying the operation at the time of connecting and disconnecting the image forming apparatus with and from the USB memory (fourth embodiment);

FIG. 12 is a diagram exemplifying the operation at the time of connecting and disconnecting the image forming apparatus with and from the USB memory (fifth embodiment);

FIG. 13 is a diagram exemplifying the operation at the time of connecting and disconnecting the image forming apparatus with and from the USB memory (sixth embodiment, writing of authentication information); and

FIG. 14 is a diagram exemplifying the operation at the time of connecting and disconnecting the image forming apparatus with and from the USB memory (sixth embodiment, reading of authentication information).

### DETAILED DESCRIPTION

In accordance with an embodiment, an image forming apparatus comprises a display section, a connection section and a controller. The connection section connects with a device having a storage section. The controller detects connection and disconnection with and from the device by the connection section and does not display a first screen displayed on the display section due to the connection with the device if the disconnection is detected.

The image forming apparatus of the embodiment has a terminal conforming to a USB standard to be capable of connecting with a USB device. The image forming apparatus of the embodiment can read and write data from and to an external storage device conforming to the USB standard. The image forming apparatus of the embodiment has a function of forming an image on a sheet and a function of decoloring the image on the sheet formed with a decoloring material.

The image forming apparatus of the embodiment can carryout both a printing with a decoloring color material and a printing with non-decoloring color material. The decoloring color material is fixed on the sheet if heated at a prescribed fixing temperature or higher, and is decolored if heated to a prescribed decoloring temperature higher than the fixing temperature. The decoloring color material includes a color developing compound, a color developing agent and a decoloring agent. For example, leuco dyes are exemplified as the color developing compound. Phenols are exemplified as the color developing agent. A matter which is blended with the color developing compound if heated and has no affinity to the color developing agent is exemplified as the decoloring agent. The decolorable color material develops color through interaction between the color developing compound and the color developing agent and is decolored as the interaction between the color developing compound and the color developing agent is cut off by the heating at a temperature higher than or equal to the decoloring temperature.

Further, in the embodiment, toner is exemplified as the color material; however, the form of the embodiment is also applied to a case of executing an image forming processing with ink. The “decoloring” in the embodiment refers to making an image formed with a color (containing not only chromatic colors but also achromatic colors such as white, black and the like) different from a base color of the sheet invisible visually. The “invisible visually” refers to making the image formed with the color different from the base color of the sheet change to a color identical or similar to the base color of the sheet in addition to a form in which the image formed with the color different from the base color of the sheet is colorless (transparent).

Hereinafter, the present embodiment is described with reference to the accompanying drawings. Further, in the following description, a USB memory is described as an example of the external storage device conforming to the USB standard; however, the external storage device may be any device as long as it is a device including a storage section such as a portable terminal or an externally attached HDD.

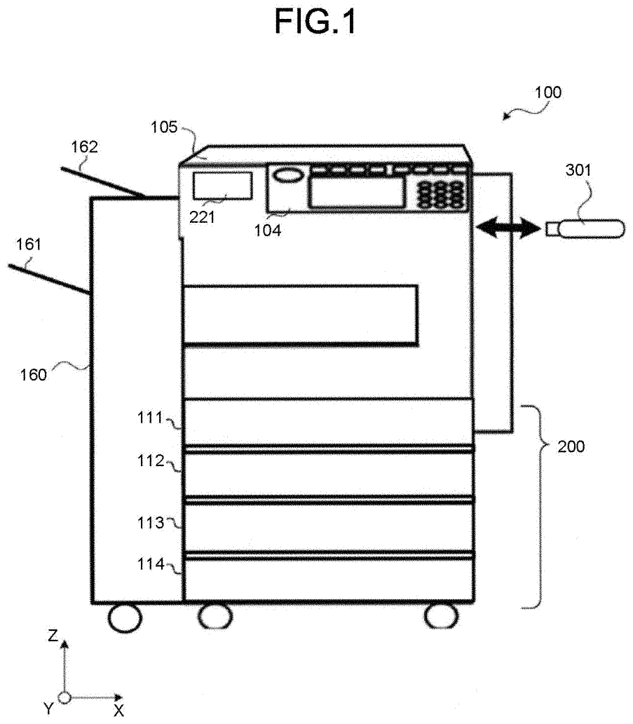

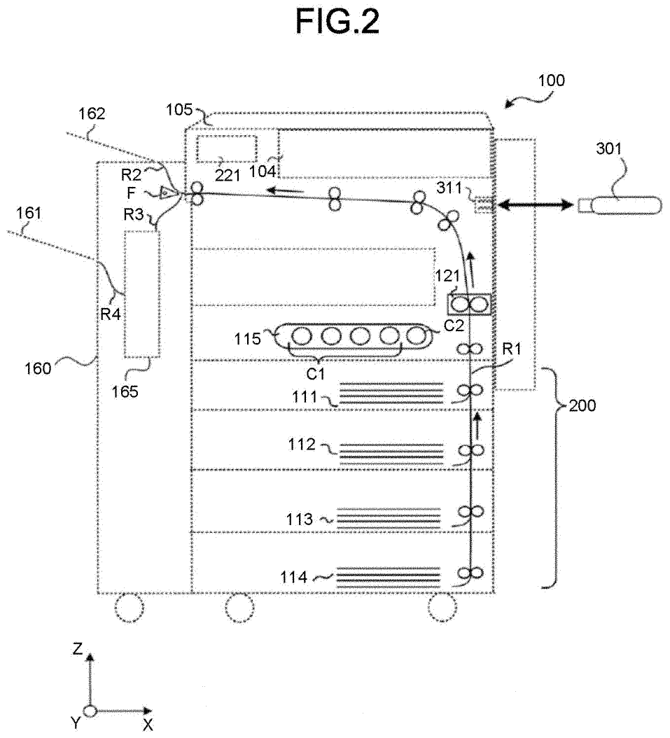

FIG. 1 is a diagram illustrating an image forming apparatus according to the embodiment, and FIG. 2 is a pattern diagram exemplifying the internal constitution of the image forming apparatus. Further, X axis, Y axis and Z axis in each figure are common. An arrow in FIG. 2 indicates a conveyance direction of a sheet. The constitution of an image forming apparatus 100 is described later with reference to FIG. 2.

The image forming apparatus 100 has cassettes 111, 112, 113 and 114 for housing the sheet and supplying the sheet at the time of executing a job. The cassettes 111, 113 and 114 respectively house unused new sheets with different sizes. The cassette 112 houses a sheet which is an object of a decoloring processing after used. The decoloring processing in the present embodiment refers to a processing of heating the sheet on which an image is formed with a decoloring color material to a prescribed decoloring temperature or higher. The cassettes 111, 113 and 114 are called normal cassettes, and the cassette 112 is called a reuse cassette. The cassettes 111˜114 are set to a sheet feed section 200.

The image forming apparatus 100 has an image forming section 115 for forming an image on the sheet. The image forming section 115 can execute both a printing with a decoloring color material and a printing with a non-decoloring color material. The image forming section 115 has a cartridge C1 for housing the non-decoloring color material which is the normal color material and a cartridge C2 for housing a decoloring color material which is decolorized at the prescribed decoloring temperature or higher. The cartridge C1 is composed of cyan, magenta, yellow, and black cartridges. The image forming apparatus 100 has a heating device 121 for heating and pressurizing the sheet on which the image is formed to fix the image on the sheet. The heating device 121 increases the temperature up to the decoloring temperature to decolorize the image on the sheet housed in the reuse cassette 112 (decoloring processing).

The image forming apparatus 100 has a conveyance path R1 for conveying the sheet in the order of a sheet feed section 200, an image forming section 115, the heating device 121 and a post-processing apparatus 160 described later. The image forming apparatus 100 has an operation panel 104 for receiving an input of a parameter value such as a printing number and an instruction of starting a processing from a user to display a job process. The image forming apparatus 100 has a scanning section 105 for reading a document sheet arranged on a transparent glass plate. The image read by the scanning section 105 is output to the image forming section 115 and the image forming section 115 forms the image on the sheet (copy processing).

The image forming apparatus 100 has a terminal 311 conforming to the USB standard to be capable of connecting with the USB memory 301. In the USB standard, there are plural versions according to the order in which specifications are fixed, and the terminal 311 can connect with any version of device.

The image forming apparatus 100 has a card reader 221. The card reader 221 reads an authentication information such as a user ID and a password from an IC card carried by the user. The authentication information is used to determine presence of a use authority to the image forming apparatus 100 for the user. If the authentication information is matching, the user can use the image forming apparatus 100. Contrarily, if the authentication information is not matching, the user cannot use the image forming apparatus 100. A restriction may be provided for each function according to the authority of the user, such as making some functions usable and prohibiting the use of other functions.

The image forming apparatus 100 has the post-processing device 160 that is optionally mountable. The post-processing device 160 switches a path by a flapper F to continue to convey the sheet conveyed via a conveyance path R1 in a conveyance path R2 or a conveyance path R3. If the sheet is conveyed to the conveyance path R2, the sheet is output to a discharge tray 162 without any changes. On the other hand, if the sheet is conveyed to the conveyance path R3, a post-processing section 165 bundles a plurality of sheets and aligns them to execute a post-processing such as a staple processing or center folding processing, and executes a punching processing for each sheet as the post-processing. After the post-processing is executed, the sheet or the sheet bundle is output to a discharge tray 161 via a conveyance path R4.

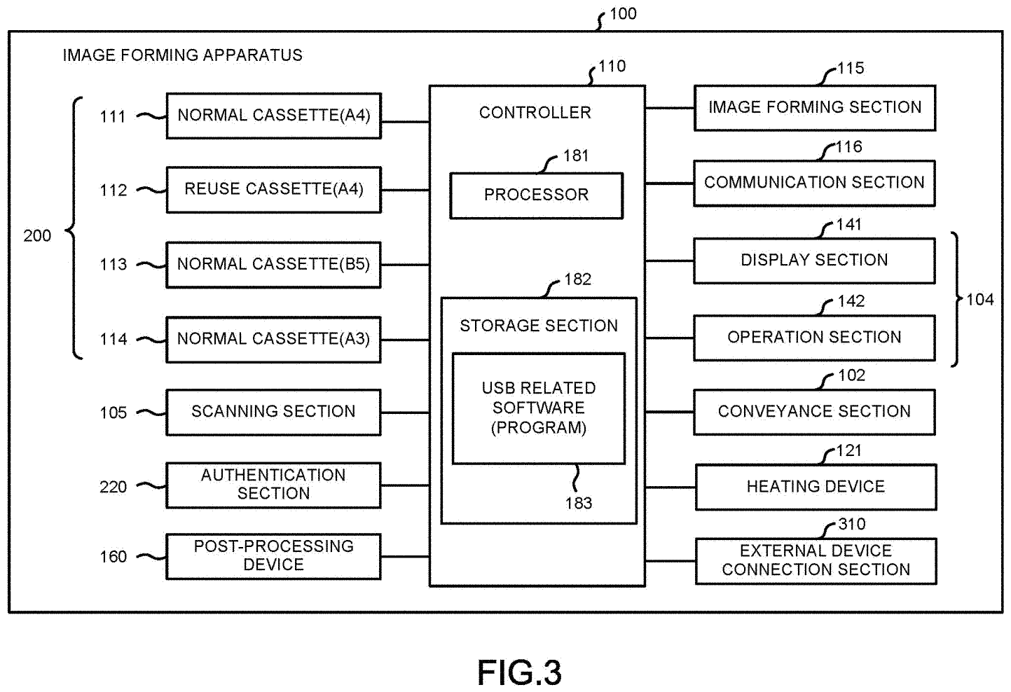

FIG. 3 is a block diagram exemplifying the constitution of the image forming apparatus 100. The image forming apparatus 100 includes a controller 110 at least including a processor 181 and a storage section 182. The processor 181 is an arithmetic processing device such as a CPU (Central Processing Unit). The processor 181 executes programs stored in the storage section 182 to realize various functions. The storage section 182 includes a main storage device that stores data in a volatile manner and directly inputs and outputs data from and to the processor 181. Further, the storage section 182 includes a ROM and an auxiliary storage device, and stores a USB related software 183 (program) and data in a nonvolatile manner. The processor 181 computes and executes the USB related software 183, and in this way, the controller 110 collectively controls main body units of the image forming apparatus 100 and provides functions described below. Further, a part or all of the functions provided by the controller 110 may be implemented by a circuit such as an ASIC (application specific integrated circuit).

The image forming apparatus 100 has a communication section 116. The communication 116 receives print data from a personal computer based on an instruction of the controller 110. The communication section 116 sends a message relating to a processing result and a state status to the personal computer. The image forming apparatus 100 forms an image of the print data on the sheet after receiving the print data (printing processing).

The operation panel 104 includes a display section 141 which is a flat type liquid crystal monitor and an operation section 142 composed of physical buttons and a touch panel overlapped on the display section 141. A conveyance section 102 contains the conveyance path R1 to convey the sheet to each unit according to the instruction of the controller 110.

The normal cassettes 111, 113 and 114 and the reuse cassette 112 shown in FIG. 3 are as stated above; however, sizes of the sheets housed in parentheses are described in FIG. 3. In the present embodiment, the normal cassette 111 and the reuse cassette 112 house the sheets with A4 size. The normal cassette 113 houses the sheet with B5 size and the normal cassette 114 houses the sheet with A3 size. The scanning section 105, the post-processing device 160, the image forming section 115 and the heating device 121 are as stated above.

An authentication section 220 includes a card reader 221 to carry out user authentication. All the operations in the user authentication processing may be executed by the image forming apparatus 100 or a match determination may be executed by an external authentication server, for example. In this case, the image forming apparatus 100 reads the authentication information by using the card reader 221, and the authentication server carries out the match determination. The image forming apparatus 100 receives a determination result from the authentication server to control permission and rejection of execution of each function.

An external device connection section 310 includes the terminal 311 for the USB connection to connect and disconnect the image forming apparatus 100 with and from the USB memory 301. The external device connection section 310 detects an output level of each signal of D+ and D- to output the output level to the controller 110. The controller 110 detects the connection and disconnection with and from the USB memory 301 based on the output level.

Hereinafter, each embodiment is described.

### First Embodiment

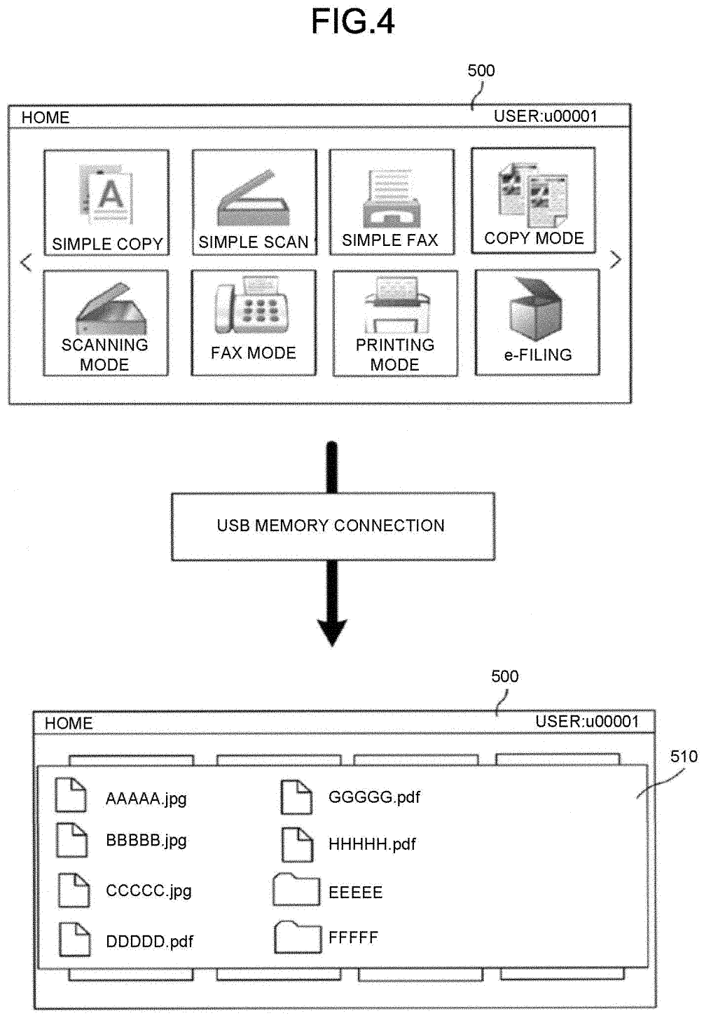

FIG. 4 is a diagram illustrating an example of a screen transition at the time the USB memory 301 is connected. The image forming apparatus 100 displays a home screen 500 (may also be called a main menu screen or waiting screen) on the operation panel 104 after the user completes a login authentication. At this time, if the user connects the USB memory 301 to the terminal 311, the processor 181 copies or decompresses a prescribed software (USB related software 183) on a volatile storage area of the storage section 182 to execute (start) the USB related software 183. The USB related software 183 contains a code for displaying a screen 510 (first screen) shown at lower part in FIG. 4 on the operation panel 104. In other words, the processor 181 executes the USB related software 183 to display the screen 510 on the operation panel 104.

The screen 510 is a screen for displaying a list of files or folders stored in the USB memory 301. The user selects a file in the list to execute a job designated by the user such as a printing of the file, faxing the file or sending the file by E-mail. If the folder is selected, a list of files or folders stored in the folder is displayed. If a scan job is executed, the data after scanning is stored in the USB memory 301, display content is updated and the data file is also contained in the list display.

In the present embodiment, the USB related software 183 is prepared as a command. The processor 181 detects a signal at the time the USB memory 301 is connected to execute the command of the USB related software 183 via an OS. In addition, the USB related software 183 may be always activated.

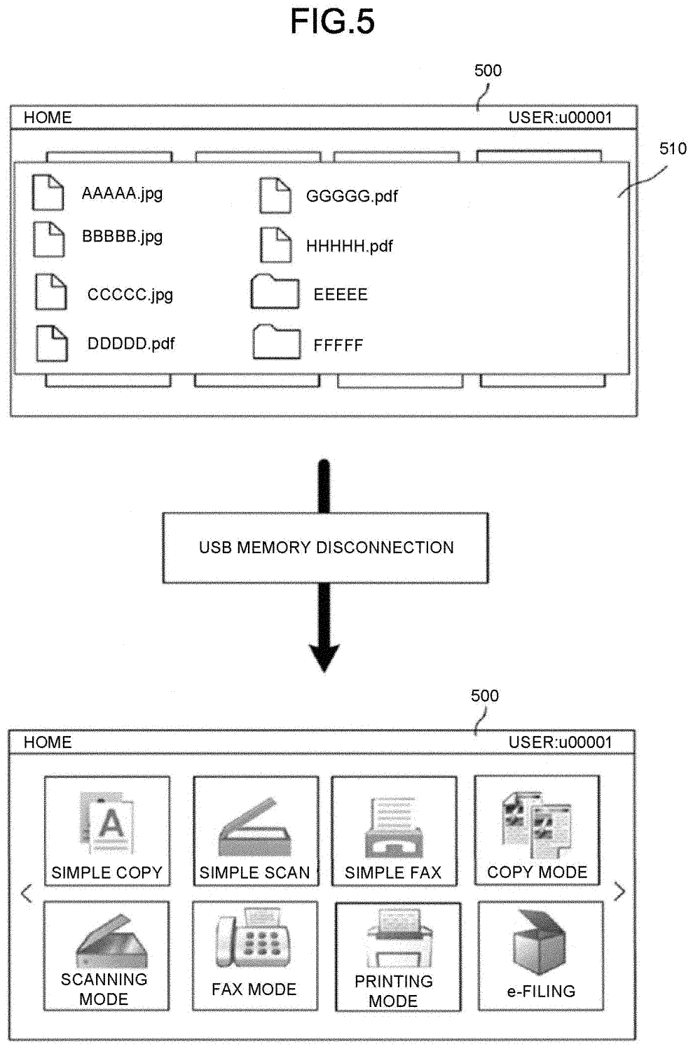

FIG. 5 is a diagram illustrating an example of a screen transition at the time the USB memory 301 is removed and disconnected. If the user removes the USB memory 301 from the terminal 311, the processor 181 detecting the disconnection ends the USB related software 183 to release the nonvolatile storage area of the storage section 182. By ending the software, the display of the screen 510 is closed and is not displayed and the home screen 500 is displayed as shown at the lower part in FIG. 5. At the time of the disconnection, the OS notifies the USB related software 183 that the USB memory 301 is removed, and the USB related software 183 receiving the notification terminates execution.

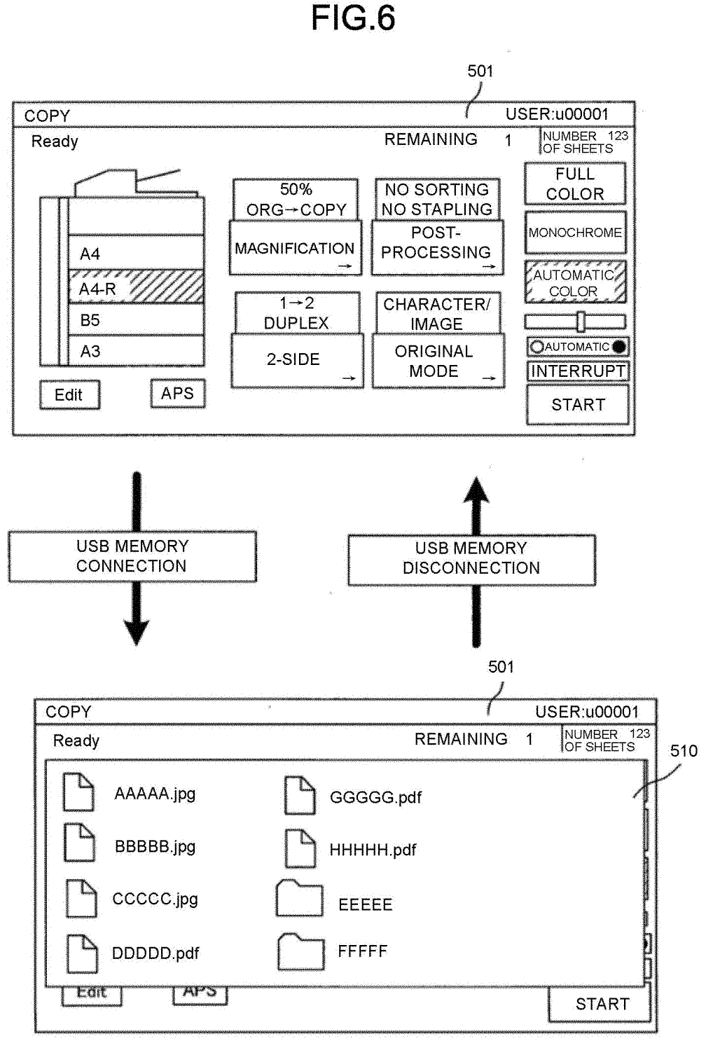

In the example in FIG. 5, after the disconnection, no matter what screen content is displayed before the connection, the screen always returns to the home screen. In addition, the screen may return to a screen displayed at the time of the USB memory 301 is connected. The example is shown in FIG. 6. A copy screen 501 shown in the upper part of FIG. 6 is displayed by pressing a copy mode button on the home screen 500. If the user connects the USB memory 301 while displaying the copy screen 501, the processor 181 starts the USB related software 183 to display the screen 510 (screen transition from the upper part to the lower part in FIG. 6). If the USB memory 301 is removed by the user, the processor 181 terminates the USB related software 183, closes the screen 510, and displays the copy screen 501 displayed before the connection (screen transition from the lower part to the upper part). In addition, the screen may return to the login screen (screen showing “please hold IC card”).

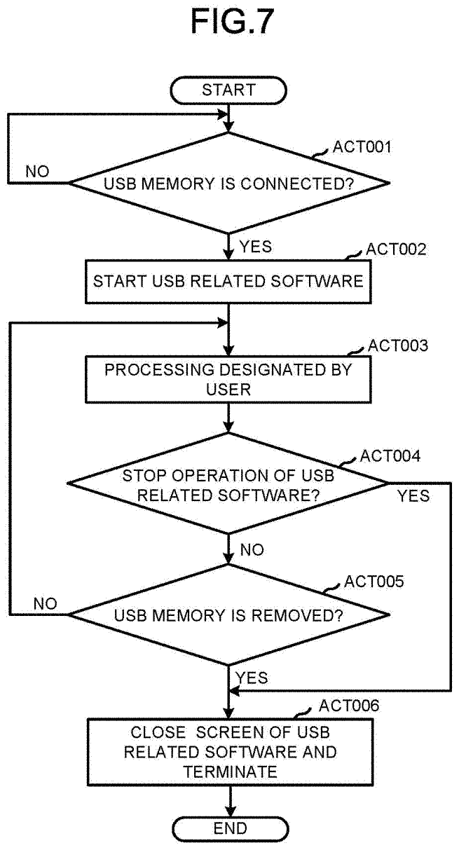

FIG. 7 is a flowchart illustrating the operation in a first embodiment. The processor 181 determines whether the USB memory 301 is connected (ACT 001), and stands by until the USB memory 301 is connected (ACT 001: loop of No). If the USB memory 301 is connected (ACT 001: Yes), the processor 181 starts the USB related software 183 (ACT 002). Thus, the operation panel 104 displays the screen 510.

The processor 181 executes a processing designated by the user (ACT 003). The operation in ACT 003 is described. The processor 181 displays a dialogue screen for displaying a list of jobs such as printing, faxing and E-mail sending on the operation panel 104 if the user selects (touch presses) the file on the screen 510. If the user selects one job in the dialogue, the processor 181 controls each hardware to execute the selected job. In a case of the scan job, a document sheet is set in the scanning section 105, and by pressing a start button (not shown), the processor 181 stores the scanned image in the USB memory 301.

The processor 181 determines whether or not a stop operation of the USB related software 183 is executed (ACT 004). In the present embodiment, if the screen 510 is touched and an operation for pulling (flicking) in one of the up, down, left, and right directions is received, the USB related software 183 is stopped. If such a stop operation is executed (ACT 004: Yes), the processor 181 terminates the execution of the USB related software 183 (ACT 006). Thus, the processor 181 closes the screen 510 and does not display it. If the stop operation of USB related software 183 is not executed (ACT 004: No), the processor 181 detects or determines whether or not the USB memory 301 is removed (ACT 005). If the USB memory 301 is not removed (ACT 005: No), the flow returns to the processing in ACT 003. If the USB memory 301 is removed (ACT 005: Yes), the processor 181 terminates the execution of the USB related software 183 and also closes the screen 510 (ACT 006).

According to the present embodiment, it is possible to smoothly transfer to operations relating to the USB memory, and also smoothly get rid of operations relating to the USB memory.

### Second Embodiment

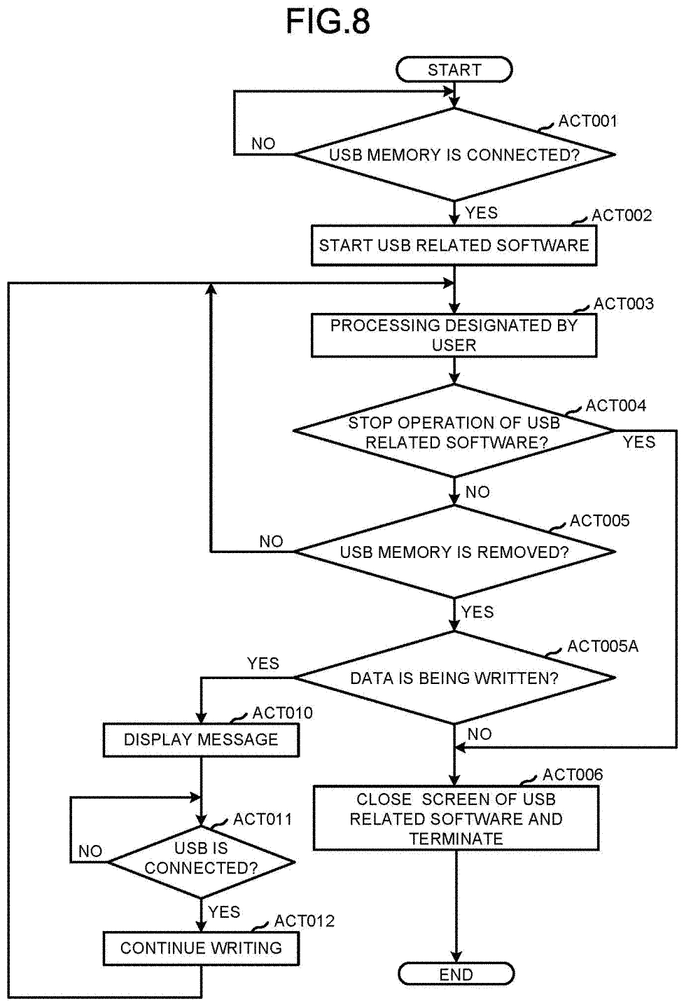

Next, an example of the operation at the time the USB memory 301 is removed while the data is being written to the USB memory 301 (while the data is being transferred) is described with reference to FIG. 8. The processing in ACT 001˜ACT 005 in FIG. 8 is same as that in FIG. 7. In ACT 005, if the USB memory 301 is removed (ACT 005: Yes), the processor 181 determines whether or not the data is being written (ACT 005A). If there is no data that is being written (ACT 005A: No), the processor 181 terminates the execution of the USB related software 183, closes the screen 510 and terminates the processing in FIG. 8. If there is the data that is being written (ACT 005A: Yes), the processor 181 notifies that the writing of the data is not completed by, for example, displaying a message on the operation panel 104 (ACT 010). Then, the processor 181 determines whether or not the USB memory 301 is connected again (ACT 011), If the USB memory 301 is connected again (ACT 011: Yes), the processor 181 continues the writing (ACT 012). Further, the processor 181 holds information (pointer) indicating how far the data is written to the USB memory 301 at the time of writing and restarts the writing based on the information in ACT 012. In addition, the processor 181 may write the data from the beginning again.

In the second embodiment, in a case in which failure occurs at the time of removing the USB memory 301, a case in which the USB related software 183 is continued without being ended to be capable of executing the USB related operation. In the present embodiment, a case in which the USB memory 301 is removed in the process of writing is described as an example; however, in a situation in which the failure occurs in a case of removing the USB memory 301, by applying the second embodiment, it is possible that the USB related software 183 is not ended. In the above embodiment, the writing of the data is mainly described; however, the second embodiment is also applied while the data is being read out from the USB memory 301. In other words, the second embodiment can be applied in a case in which data transfer with the USB memory 301 is being executed.

### Third Embodiment

In the first and the second embodiments, in a case in which the USB memory 301 is removed, a case in which the screen 510 is closed and terminated is described. However, even if the USB memory 301 is removed, in a case in which a reading operation is continuously executed to another USB memory, it is preferable that the screen 510 is continuously displayed without any changes. In the third embodiment, an example is described in which whether to terminate the software 183 is controlled according to the determination of the user if the USB memory 301 is removed.

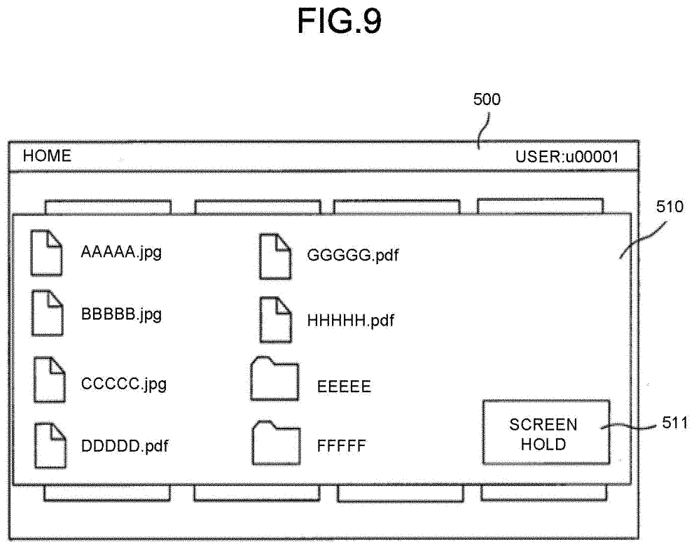

FIG. 9 illustrates the screen 510 in the third embodiment. The screen 510 shown in FIG. 9 has a hold button 511. If the hold button 511 is pressed, even if the USB memory 301 is removed, the processor 181 does not stop the operation of the USB related software 183 and continues to display the screen 510. Further, the hold button 511 is in a press state only when the hold button 511 is continuously touched in the present embodiment and the screen 510 is held; and if the hold button 511 is released, the press state is released and the screen 510 is not held. Of course, the press state and press release may be repeated every time the hold button 511 is touched.

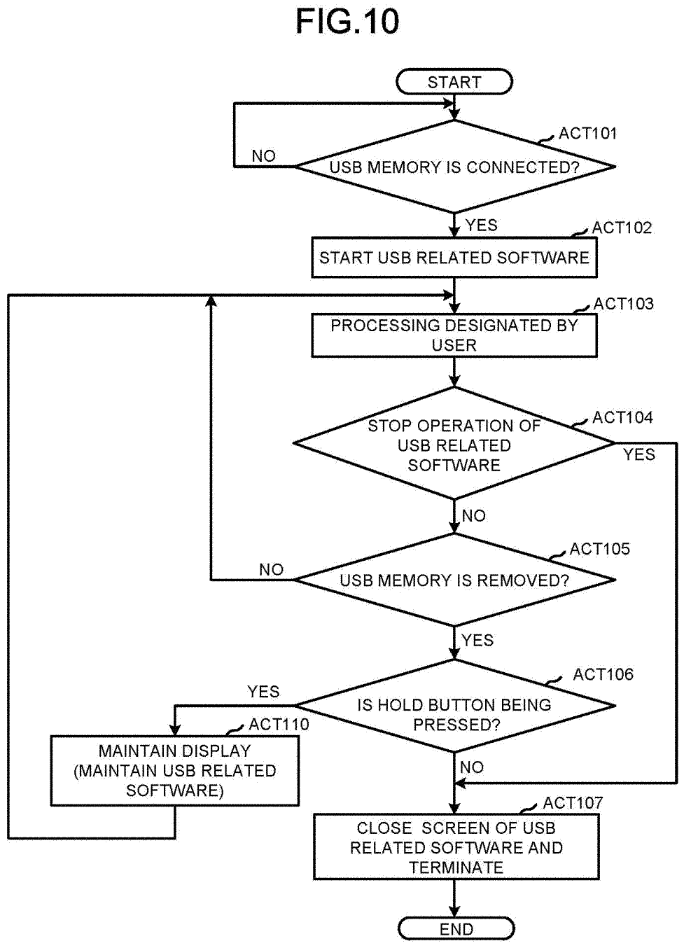

FIG. 10 is a flowchart illustrating the operation in the third embodiment. The processing in ACT 101˜ACT 105 is the same as that in ACT 001˜005 in FIG. 7. In ACT 105, if the USB memory 301 is removed (ACT 105: Yes), the processor 181 determines whether the hold button 511 is being pressed (ACT 106). If the hold button 511 is pressed (ACT 106: Yes), the processor 181 continues to start the USB related software 183 to continuously display the screen 510 (ACT 110). If the hold button 511 is not pressed (ACT 106: No), the processor 181 terminates the execution of the USB related software 183, closes the screen 510 and terminates the processing (ACT 107).

In the above embodiment, the control for closing or not closing the screen 510 is carried out depending on whether the hold button 511 is pressed or not. The present embodiment is merely an example, and if the user performs a previously defined operation, the processor 181 carries out control so as to close (or not close) the screen 510.

### Fourth Embodiment

In the fourth embodiment, an example is described in which the screen 510 is closed (or not closed) in the case of a specific USB version.

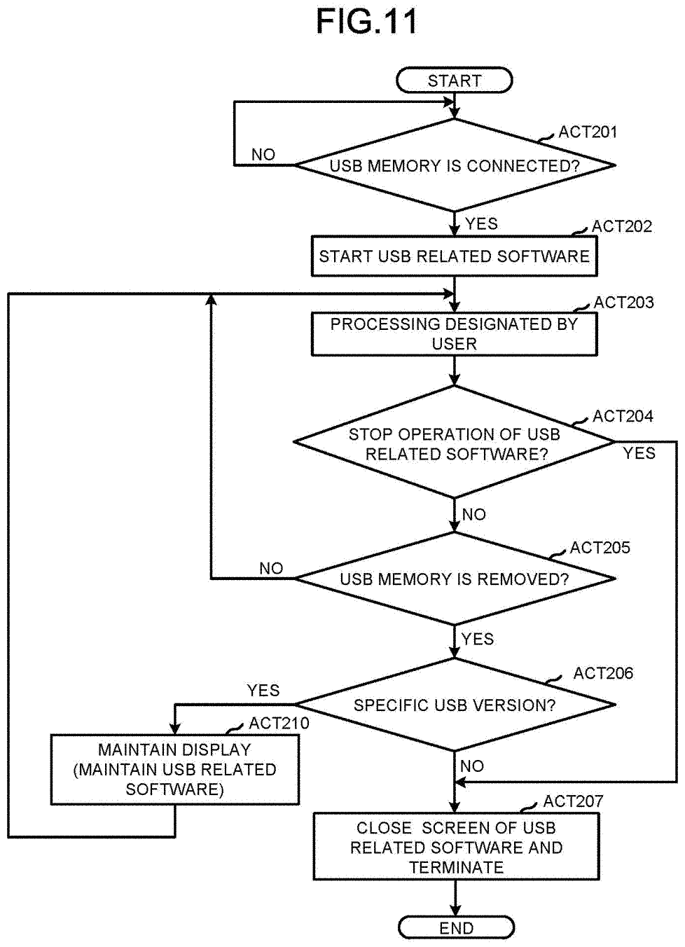

FIG. 11 is a flowchart illustrating the operation in the fourth embodiment. The processing in ACT 201˜ACT 205 is the same as that in ACT 001˜005 in FIG. 7. In ACT 205, if the USB memory 301 is removed (ACT 205: Yes), the processor 181 determines whether or not the USB version of the USB memory 301 is a previously defined specific version (ACT 206). If the USB version of the USB memory 301 is the specific version (ACT 206: Yes), the processor 181 continues to start the USB related software 183 to continuously display the screen 510 (ACT 210). If the USB version of the USB memory 301 is not the specific version (ACT 206: No), the processor 181 terminates the execution of the USB related software 183, closes the screen 510 and terminates the processing (ACT 207).

### Fifth Embodiment

In the fifth embodiment, at the time the USB memory 301 is removed, an operation of recording the job log is described. In recent years, there is a case in which confidential data is leaked to the outside by using a portable storage device such as a USB memory. It is preferable to be able to trace the process when such information leakage occurs. In the fifth embodiment, an example for recording such a traceable job log is described.

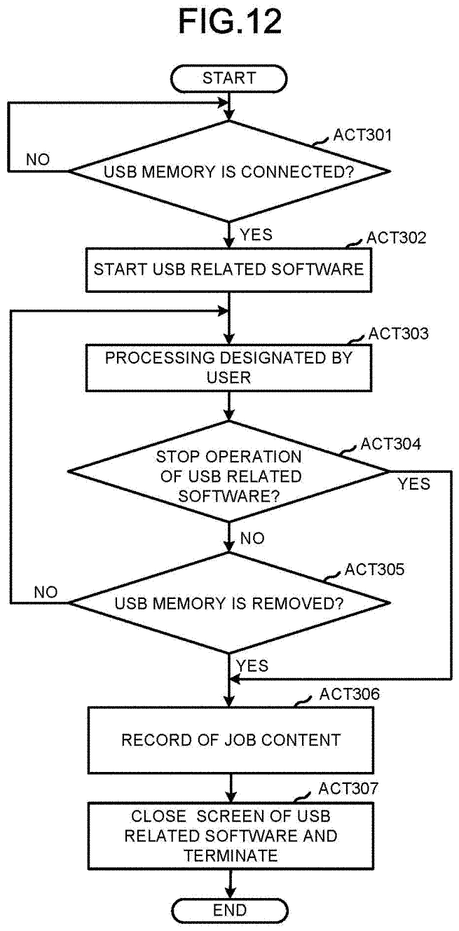

FIG. 12 is a flowchart illustrating the operation in the fifth embodiment. The processing in ACT 301˜ACT 305 is the same as that in ACT 001˜005 in FIG. 7. In ACT 305, if the USB memory 301 is removed (ACT 305: Yes), the processor 181 stores the job logs (operation logs) so far, for example, in the storage section 182 (ACT 306). The collected logs are, for example, data in which a user ID, execution time, a type and content of a job and a file name used are associated with each other. The data may transmitted to a log server (not shown) to be stored.

Then, the processor 181 terminates the execution of the USB related software 183, closes the screen 510 and terminates the processing (ACT 307).

### Sixth Embodiment

In the sixth embodiment, an example in which the authentication information is stored in the USB memory 301 at the time of login by using the IC card. In the sixth embodiment, in addition to the login authentication by using the IC card, it is also possible to execute the authentication operation by using the authentication information stored in the USB memory 301.

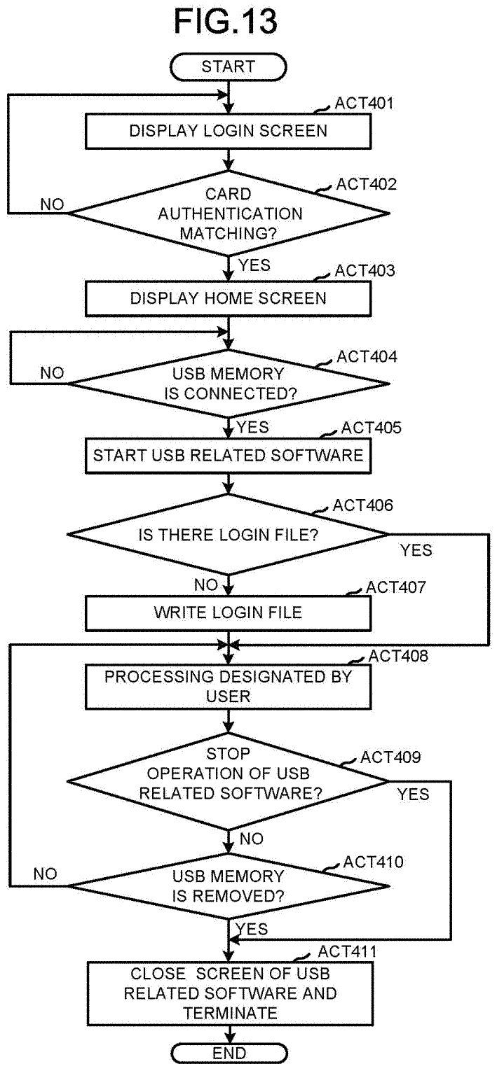

FIG. 13 is a diagram illustrating a series of operations at the time of storing the authentication information in the USB memory 301. The processor 181 controls the operation panel 104 to display a login screen if there is no operation at the time a power source of the image forming apparatus 100 is turned on or a certain time elapses (ACT 401).

The processor 181 carries out the authentication processing to the user by using the authentication information in the IC card held over the card reader 221 to determine whether or not the use of the user is matching (whether to permit the use) (ACT 402). If it is authenticated that the use is not matching (ACT 402: No), the processor 181 enables a message indicating that the user is not matching to be displayed and returns to the processing in ACT 401.

If it is authenticated that the user is matching (ACT 402: Yes), the processor 181 displays the home screen 500 on the operation panel 104 (ACT 403) to carry out connection determination of the USB and start of the USB related software 183 similar to the processing in ACTs 001 and 002 in FIG. 7 (ACT 404 and ACT 405). The USB related software 183 is programmed to perform the operations described in ACT 406 and the following. The processor 181 determines whether or not a login file is stored in the USB memory 301 (ACT 406). The login file is stored in a previously defined specific folder and is assigned with a specific file name. If there is no login file (ACT 406: No), the processor 181 files the authentication information in the IC card used in ACT 402 to store the filed authentication information in the USB memory 301 as the login file (ACT 407). At this time, the authentication information is encrypted with a predefined encryption method or key. If there is the login file (ACT 406: Yes), in the present embodiment, ACT 407 is skipped. However, even if there is no login file, the processing in ACT 407 may be executed to update the login file (to follow password change, for example).

The processing in ACT 408˜ACT 411 is similar to that in ACT 003˜ACT 006 shown in FIG. 7, and thus the description thereof is omitted.

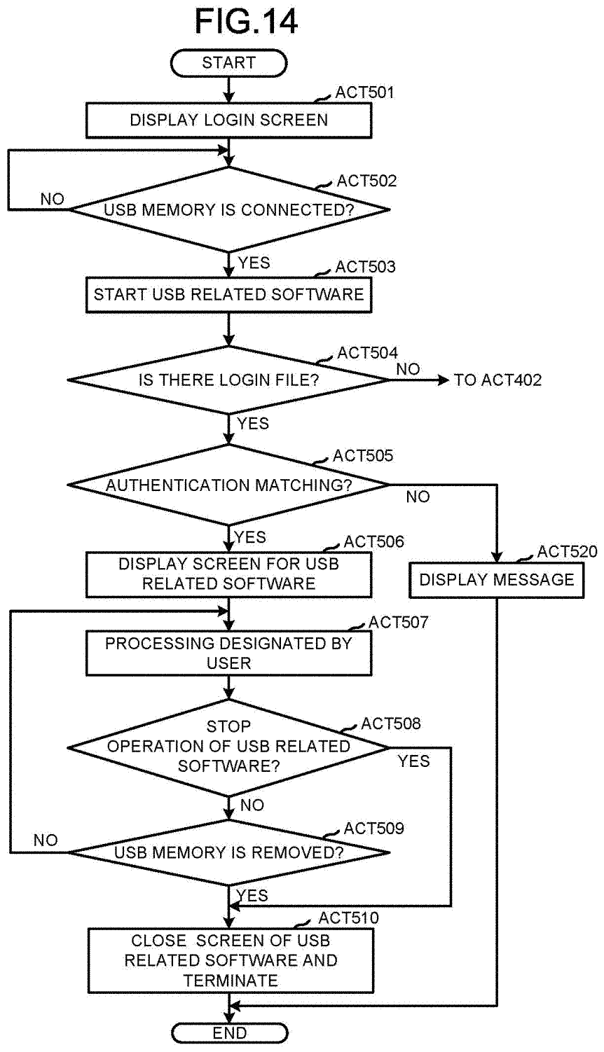

FIG. 14 is a diagram exemplifying the operation for carrying out authentication by using the authentication information stored in the USB memory 301. The processor 181 controls the operation panel 104 to display the login screen (ACT 501). The detection determination of the USB memory in ACT 502 afterwards and the start of the USB related software 183 in ACT 503 are the same as those in ACT 001 and ACT 002 in FIG. 7.

The processor 181 determines whether or not there is the login file (ACT 504). If there is no login file (ACT 504: No), in the present embodiment, the processor 181 stops the started USB related software 183 to switch to login by a conventional IC card (to ACT 402 in FIG. 13). If there is a login file (ACT 504: Yes), the processor 181 decrypts the encrypted data in the file and executes the authentication processing to determine whether or not the user is matching (ACT 505). If it is authenticated that the user is not matching (ACT 505: No), a message indicating that the user is not matching is displayed (ACT 520), and the processing is terminated. After a message indicating that the user is not matching is displayed, the processor 181 may switch to login by a normal IC card (switching to ACT 402 in FIG. 13).

If it is authenticated that the user is not matching (ACT 505: Yes), the processor 181 displays the screen 510 (ACT 506).

The processing in ACT 507˜ACT 510 is the same as that in ACT 003˜ACT 006, and thus the description thereof is omitted.

In a case in which a user who is a maintenance person is logged in, if a user with a specific authority (administrative authority, maintenance authority) uses the image forming apparatus 100, after the USB memory 301 is removed, the image forming apparatus 100 may be restarted or the power source thereof is turned off.

Each of the above embodiments may be independently implemented or a combination of a plurality of the above embodiments may be implemented. In the above embodiment, the interface connecting with the external device is described as the interface conforming to the USB standard; however, the present invention is not limited to this. As long as it is an interface capable of detecting the connection and the disconnection, the interface may be connected in a wired manner or a wireless manner.

As described in detail above, according to the technology described in this specification, at the time the USB memory is connected, it is possible to easily transfer to the operation using the USB memory, and at the time the USB memory is detached, it is possible to easily transfer from the operation using the USB memory to another operation.

The present invention can be implemented in a variety of other forms without departing from the spirit or main characteristics of the invention. Therefore, the above embodiments are merely examples in all respects but not as limitations. The scope of the present invention is illustrated by the scope of the accompanying claims and is not limited to this specification. Furthermore, various improvements, substitutions and reforms belonging to the equivalent scope of the scope of the claims all fall within the scope of the present invention.

What is claimed is:

1. An image forming apparatus, comprising:
a display device; and
a processor that executes instructions to perform operations, comprising:
connecting with a device having a storage device;
detecting a connection and a disconnection of the device;
maintaining a pointer location representing data comprising a first screen;
displaying the first screen on the display device in response to detection of the connection of the device, and
in response to detecting that the device is disconnected and the pointer location, not displaying the first screen on the display device and immediately displaying a home screen.

2. The image forming apparatus according to claim 1, wherein the operations further comprise:
in response to detecting that the device is disconnected at a time data is not being transmitted between the image forming apparatus and the device, not displaying the first screen on the display device, and
in response to detecting that the device is disconnected at the time data is being transmitted between the image forming apparatus and the device, displaying the first screen on the display device.

3. The image forming apparatus according to claim 1, wherein the operations further comprise:
in response to detecting reconnection of the device, resuming data transmission between the image forming apparatus and the device.

4. The image forming apparatus according to claim 1, wherein the operations further comprise:
in response to determining that a previously defined operation has been executed, displaying the first screen on the display device.

5. The image forming apparatus according to claim 2, wherein the operations further comprise:
in response to determining that a previously defined operation has been executed, display the first screen on the display device.

6. The image forming apparatus according to claim 1, wherein the operations further comprise:
storing, in response to detecting the disconnection, a job content to the device in the storage device.

7. The image forming apparatus according to claim 1, wherein the operations further comprise:
determining whether or not authentication information for performing a determination of whether to permit a use of the image forming apparatus is stored in the storage device of the device based on determining that the connection with the device is detected; and in response to determining that the authentication information is stored, using the authentication information to determine whether to permit the use of the image forming apparatus.

8. A method for operating an image forming apparatus, wherein the image forming apparatus comprises a display device, and a processor, the method comprising:
detecting, by the image forming apparatus, connection and disconnection of a device comprising a storage device,
maintaining, by the image forming device, a pointer location representing data comprising a first screen;
displaying, by the image forming apparatus, the first screen on the display device based on the pointer location and in response to detecting the connection by the device, and
not displaying, by the image forming apparatus, the first screen on the display device in response to detecting the disconnection of the device and immediately displaying a home screen.

9. The method according to claim 8, further comprising:
not displaying, by the image forming apparatus, the first screen on the display device in response to detecting the disconnection of the device at a time data is not being transmitted between the image forming apparatus and the device, and
displaying, by the image forming apparatus, the first screen on the display device in response to detecting section if the disconnection at the time data is being transmitted between the image forming apparatus and the device.

10. The method according to claim 8, further comprising:
detecting, by the image forming apparatus, a reconnection of the device, and
resuming data transmission between the image forming apparatus and the device in response to the reconnection of the device.
